(19) United States
(12) Patent Application Publication
(10) Pub. No.: US 2006/0053220 A1
(43) Pub. Date: Mar. 9, 2006

(54) Client server system, grouping method, server, program, computer-readable storage medium, client

(75) Inventors: Yutaka Konishi, Nukata (JP); Katsuya Kozawa, Kounan (JP); Shinichi Matsumoto, Niwa (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/217,443

(22) Filed: Sep. 2, 2005

Related U.S. Application Data
(63) Continuation of application No. PCT/JP03/02426, filed on Mar. 3, 2003.

(51) Int. Cl. G06F 15/173

(52) U.S. Cl. 709/224

(57) ABSTRACT

It is an object to provide a method for grouping many messages having variable formats transmitted to a unit of server from many clients in the manner that a user can easily verify such messages on the server. A client server system including a plurality of clients and a server is constituted so that the clients transmit messages to a server and the server comprises a grouping rule generating block for generating a grouping rule on the basis of comparison of messages, from the clients and a grouping block for grouping messages from the clients on the basis of the grouping rule generated by the grouping rule generating block.

### TECHNICAL FIELD

The present invention relates to a client server system and particularly to a client server system in which users can simultaneously install or apply applications and patches to a plurality of clients from only one unit of server.

### BACKGROUND ART

In the client server system, users simultaneously install or apply, in some cases, applications and patches to a plurality of clients from only one server.

In this case, each client executes a command for installation or a command for patch, but it is desirable when load of a user is considered that result of execution of the command (hereinafter, referred to as “message”) in each client can be verified with only one server.

However, for example, in some cases, commands executed by the clients are different therein as in the case where the client B executes the command for patch while the client A executes the command for installation.

Moreover, for example, the clients A and B sometimes output the messages which have the identical meanings but are different in the expressions such as “patch succeeded in computer” and “Process Completed.”

Therefore, the messages transmitted respectively to the server from each client do not conform to the determined format and are variable.

Accordingly, a problem rises in the method for grouping messages having variable formats on the server.

Here, grouping means that one or more messages are gathered as a group.

As a method of grouping the messages, any of the following two grouping methods has been employed.

In the first grouping method, messages are grouped for each client.

The messages grouped with this first grouping method are displayed on one window but this window is switched for each client.

In the second grouping method, messages including computer names and IP names of the clients are grouped using the computer names and IP names as the keys.

The messages grouped with this second grouping method are displayed on only one widow in the sequence equal to the sequence of transmission to the server.

Moreover, the messages grouped with the second grouping method are displayed in some cases on one window using a region assigned for each client.

However, the windows must be switched for each client in order to verify the messages grouped with the first grouping method. Accordingly, a problem rises here in the first grouping method that verification of messages becomes difficult when many clients exist.

Moreover, when the grouping is conducted with the second grouping method, messages of each client are displayed in one window as the mixed messages. Therefore, the second grouping method has a problem that users cannot easily verify the messages because a plurality of lines of display is performed when many messages exist or because display is performed in many regions when many clients exist.

Therefore, considering the background explained above, an object of the present invention is to provide a method with which a user can form groups of many messages having variable formats transmitted from many clients to only one server in order to easily verify such messages on the server.

### DISCLOSURE OF THE INVENTION

According to the present invention, the object explained above can be achieved with the following means.

The first invention is a client server system including a plurality of clients and a server. In the client server system of the first invention, the client transmits a message to the server and the server includes a grouping rule generating block for generating a grouping rule on the basis of the result of comparison of messages from the client and a grouping block for grouping the messages from the client on the basis of the grouping rule generated with the grouping rule generating block.

The second invention is a client server system in relation to the first invention. In the client server system of the second invention, the grouping rule generating block of the server selects similar two messages from those from the client and generates the rule based on the desired different portions among these two messages, while the grouping block of the server groups the messages different from above two messages only at the desired portions into a group on the basis of the grouping rule generated by the grouping rule generating block.

The third invention is a grouping method in the client server system including a plurality of clients and a server. The grouping method of the third invention includes the step that the client transmits messages to the server, the grouping rule generating step that the server compares messages from the clients and generates a grouping rule based on the result of comparison, and the grouping step that the server groups the messages from the clients on the basis of the generated grouping rule.

The fourth invention is a grouping method in relation to the third invention. In the grouping rule generating step of the grouping method of the fourth embodiment, similar two messages are selected from the messages from the client and the rule for desired different portions among these two messages is generated. Moreover, in the grouping step of the grouping method of the fourth invention, the messages different from these two messages only at the desired portion are grouped as a group on the basis of the generated grouping rule.

The fifth invention is a server. The server in the fifth invention includes a grouping rule block for comparing the messages from a plurality of clients with each other and generating a grouping rule on the basis of the result of comparison and a grouping block for grouping the messages from the client on the basis of the grouping rule generated with the grouping rule generating block.

The sixth invention is a server in relation to the fifth invention. The grouping rule generating block of the server in the sixth invention selects similar two messages from the messages from the client and generates a rule for the desired different portions among these two messages. Moreover, the grouping block of the server in the sixth invention groups the messages different from two messages only at the desired portion as a group on the basis of the grouping rule generated by the grouping rule generating block.

The seventh invention is a grouping method in the server. The grouping method of the seventh invention includes, in the server, the grouping rule generating step for comparing the messages from the client with each other and generating a grouping rule on the basis of the result of comparison, and a grouping step for grouping the messages from the client on the basis of the generated grouping rule.

The eighth invention is a grouping method in relation to the seventh invention. In the grouping rule generating step of the grouping method of the eighth invention, similar two messages are selected from the messages from the client and a rule for desired different portions among these two messages is generated. Moreover, in the grouping step in the grouping method in relation to the eighth invention, messages different from two messages only at the desired portion are grouped into a group on the basis of the generated grouping rule.

The ninth invention is a program which is executed by the server. The program of the ninth invention controls the server to execute the grouping rule generating step for comparing messages from the client with each other and generating a grouping rule on the basis of the result of comparison and the grouping step for grouping the messages from the client on the basis of the generated grouping rule.

The tenth invention is a grouping program in relation to the ninth invention. In the grouping rule generating step of the grouping program in the tenth invention, similar two messages are selected from the messages from the client and a rule for the desired different portions among these two messages is generated. Moreover, in the grouping step of the grouping program of the tenth invention, messages different from two messages only at the desired portion are grouped into a group on the basis of the generated grouping rule.

The eleventh invention is a computer-readable storage medium in which the grouping program of the ninth invention or the tenth invention is recorded.

The twelfth invention is a client transmitting a message to a server. The server to which a message is transmitted from a client in relation to the twelfth invention transmits the messages to the server including a grouping rule generating block for comparing with each other the messages from the client of the twelfth invention and generating a grouping rule on the basis of result of comparison and a grouping block for grouping the messages from the client on the basis of the grouping rule generated with the grouping rule generating block.

The thirteenth invention is a client in relation to the twelfth invention. The grouping rule generating block in the server to which messages are transmitted from the client of the thirteenth invention selects similar two messages from the messages from the client and generates a rule for the desired different portions among these two messages. Moreover, the grouping block of the server to which messages are transmitted from the client in relation to the thirteenth invention groups messages different from two messages only at the desired portion into a group on the basis of the grouping rule generated with the grouping rule generating block.

According to the present invention, a grouping rule for the grouping is dynamically generated. Therefore, according to the present invention, a user can easily verify many messages having variable formats transmitted to a unit of server from many clients.

Moreover, according to the present invention, grouping of messages transmitted to a server from each client is conducted based on the grouping rule approved by users.

Therefore, according to the present invention, a user can display messages through the desired grouping process.

Moreover, according to the present invention, a user can easily verify many messages of variable formats transmitted to a unit of server from many clients.

In addition, according to the present invention, a user can easily verify many messages having variable formats transmitted to a unit of server from many clients because the number of groups of messages can be adjusted in accordance with the number of times of the grouping process.

### BRIEF DESCRIPTION OF THE DRAWINGS

FIG. 1 is a diagram for expressing an example of function of a server to which the present invention is applied.

FIG. 2 is a diagram illustrating a first example of operations of a grouping rule generating block 2.

FIG. 3 is a diagram illustrating a second example of operations of the grouping rule generating block 2.

FIG. 4 is a diagram illustrating a first example of a verification dialog.

FIG. 5 is a diagram illustrating a first example of a grouping.

FIG. 6 is a diagram illustrating a second example of the verification dialog.

FIG. 7 is a diagram illustrating a second example of the grouping.

FIG. 8 is a diagram illustrating a third example of the verification dialog.

FIG. 9 is a diagram illustrating a third example of the grouping.

FIG. 10 is a diagram illustrating a fourth example of the verification dialog.

FIG. 11 is a diagram illustrating a fourth example of the grouping.

FIG. 12 is a diagram illustrating a fifth example of the verification dialog.

FIG. 13 is a diagram illustrating a fifth example of the grouping.

FIG. 14 is a diagram illustrating a sixth example of the verification dialog.

FIG. 15 is a diagram illustrating a sixth example of the grouping.

FIG. 16 is a diagram illustrating a seventh example of the verification dialog.

FIG. 17 is a diagram illustrating a seventh example of the grouping.

FIG. 18 is a diagram illustrating an eighth example of the grouping.

FIG. 19 is a diagram illustrating a ninth example of the grouping.

FIG. 20 is a diagram illustrating an eighth example of the verification dialog.

FIG. 21 is a diagram illustrating a tenth example of the grouping.

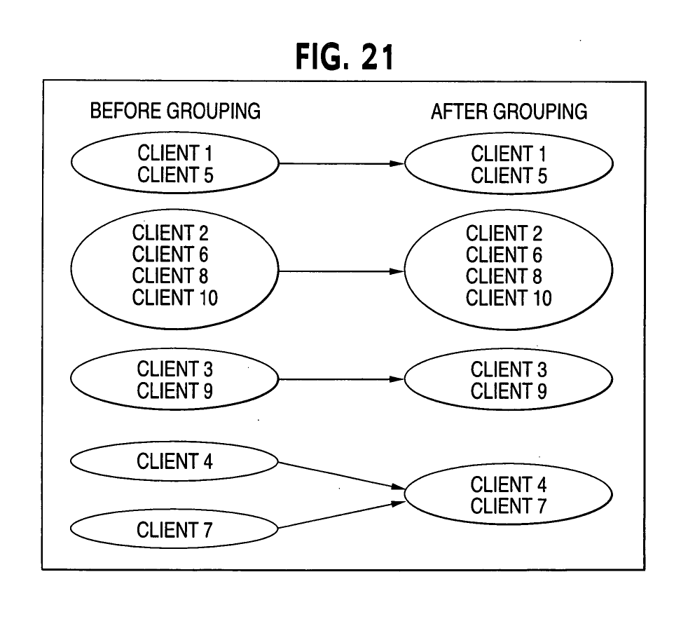

FIG. 22 is a diagram illustrating an eleventh example of the grouping.

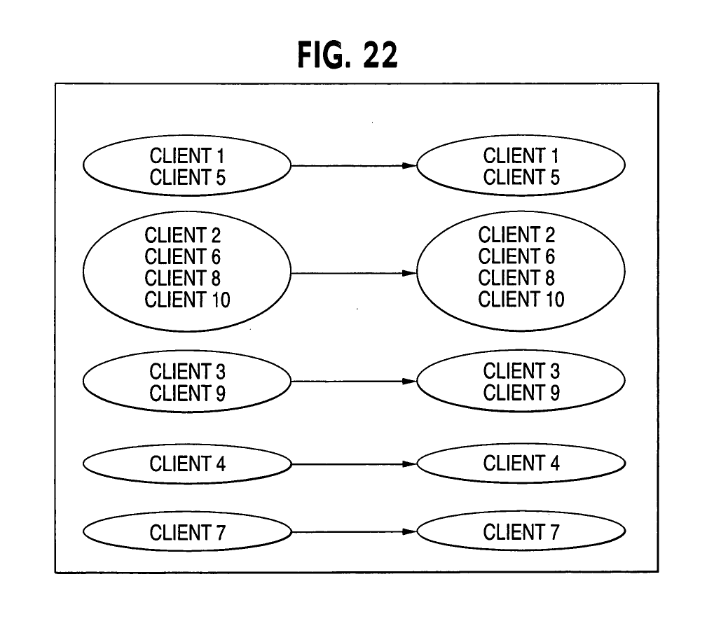

FIG. 23 is a flowchart for explaining the grouping as the first embodiment.

FIG. 24 is a flowchart (No. 1) for explaining the grouping as the second embodiment.

FIG. 25 is a flowchart (No. 2) for explaining the grouping as the second embodiment.

### BEST MODE FOR CARRYING OUT THE INVENTION

The best mode for carrying out the invention will be explained in detail with reference to the accompanying drawings.

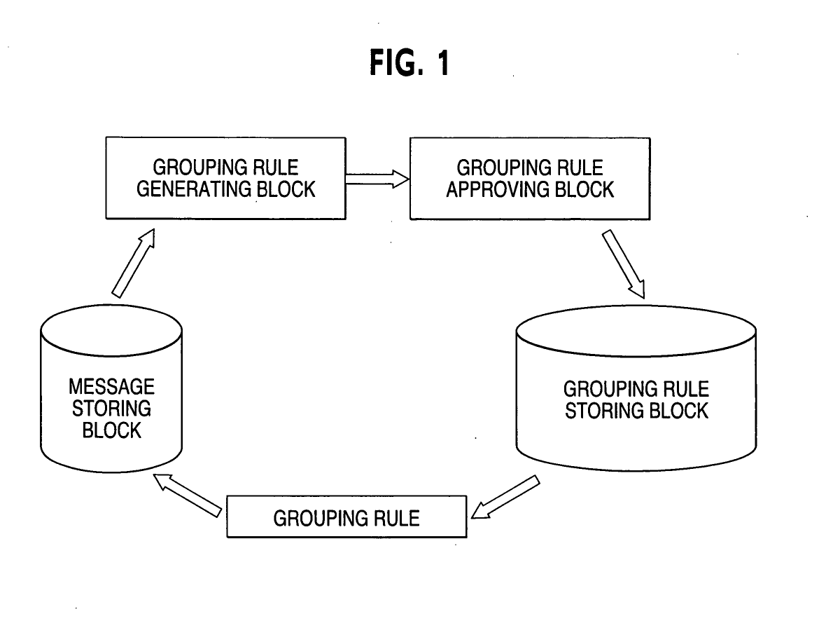

FIG. 1 is a diagram showing an example of function of a server to which the present invention is applied.

As illustrated in FIG. 1, a server to which the present invention is applied is constituted with a message storing block 1 for storing grouped messages of each client, a grouping rule generating block 2 for automatically generating a grouping rule with comparison of each message, a grouping rule approving block 3 for urging a user to approve the generated grouping rule, a grouping rule storing block 4 for storing the grouping rule approved by a user, and a grouping block 5 for actually grouping on the basis of the approved grouping rule.

Here, the message storing block 1 can be realized with a memory such as a hard disk or a main memory.

Moreover, the grouping rule generating block 2 can be realized with a CPU or a main memory.

Moreover, the grouping rule approving block 3 can be realized with a CPU, a main memory or a display.

Moreover, the grouping rule storing block 4 can be realized with a memory such as a hard disk or a main memory.

Moreover, the grouping block 5 can be realized with a CPU and a main memory.

Messages transmitted to a server from each client are first grouped into a group and are then stored into the message storing block 1.

The grouping rule generating block 2 reads only one message (temporarily designated as MsgA) from the messages stored in the message storing block 1 and sequentially compares this MsgA with the remaining messages stored in the message storing block 1.

On the basis of the result of this comparison, the grouping rule generating block 2 selects the message which is most similar to MsgA (temporarily designated as MsgZ) and generates a rule for only the different portion among these MsgA and MsgZ.

For example, when MsgA is “Client 1 Completed.” And MsgZ is “Client 2 Completed.”, these messages MsgA, MsgZ are different only at the portions “1” or “2”.

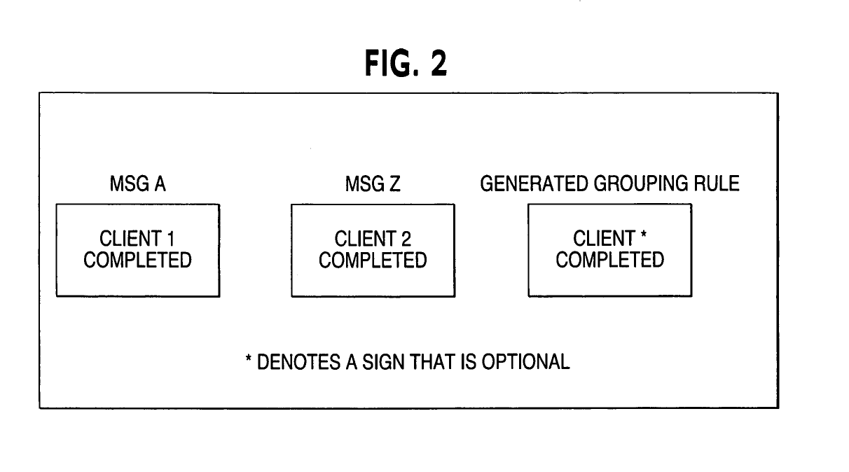

Therefore, the server generates the rule “Client * Completed.”. (FIG. 2)

When the MsgA is “Process Completed.” and the MsgZ is “Process Completed.”, any difference does not exist between the MsgA and MsgZ.

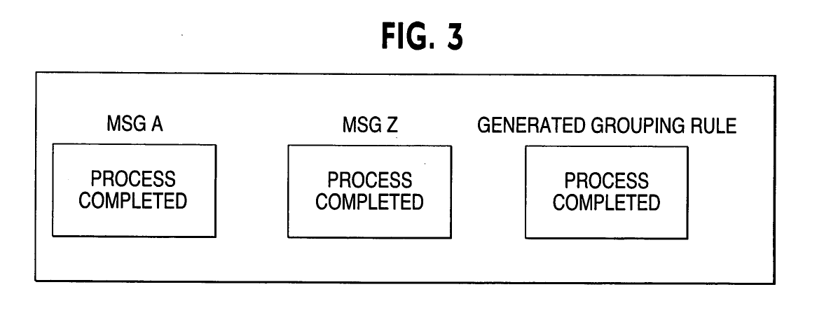

When there is no difference between the MsgA and MsgZ, the server generates a rule “Process Completed.”. (FIG. 3)

The grouping rule generated with the grouping rule generating block 2 is presented to a user with the grouping rule approving block to inquire whether a user approves this rule as the grouping rule or not.

When the user does not approve the presented grouping rule, the grouping rule generating block 2 reads the other message as the MsgA from the message storing block 1 and then executes the processes as explained above.

The grouping rule approved by a user in the grouping rule approving block 3 is then stored in the grouping rule storing block 4.

The grouping rule stored in the grouping rule storing block 4 is read out to the grouping block 5.

The grouping block 5 groups the messages stored in the message storing block 1 on the basis of the grouping rule read out from the grouping rule storing block 4.

In more practical, the messages corresponding to the grouping rule among the messages stored in the message storing block 1 are grouped into a group.

The server performs the grouping in the method similar to that explained above for the messages not corresponding to the grouping rule (hereinafter, referred to as the “messages not grouped”).

The server repeats the processes explained above and completes the grouping when a user apparently has completed the grouping, or when the message not grouped reaches 1 or 0, or when the predetermined conditions are satisfied, or when the predetermined time has passed.

The grouping conforming to the grouping rule explained above is sequentially performed for the messages not yet grouped.

Therefore, even when the grouping is conducted in accordance with the grouping rule similar to the grouping rule explained above after the grouping has been executed conforming to a certain grouping rule, the messages which are once grouped are never grouped again.

Therefore, one message does not belong to a plurality of groups.

The grouping to be conducted by the server will be explained with reference to a first embodiment and a second embodiment.

### First Embodiment

The messages transmitted to the server from each client are designated as follows.
Client 1: patch is already applied.
Client 2: patch succeeded in computer 2.
Client 3: Process Completed.
Client 4: patch command failed.
Client 5: patch is already applied.
Client 6: patch succeeded in computer 5.
Client 7: patch command failed.
Client 8: patch succeeded in computer 8.
Client 9: Process Completed.
Client 10: patch succeeded in computer 10.

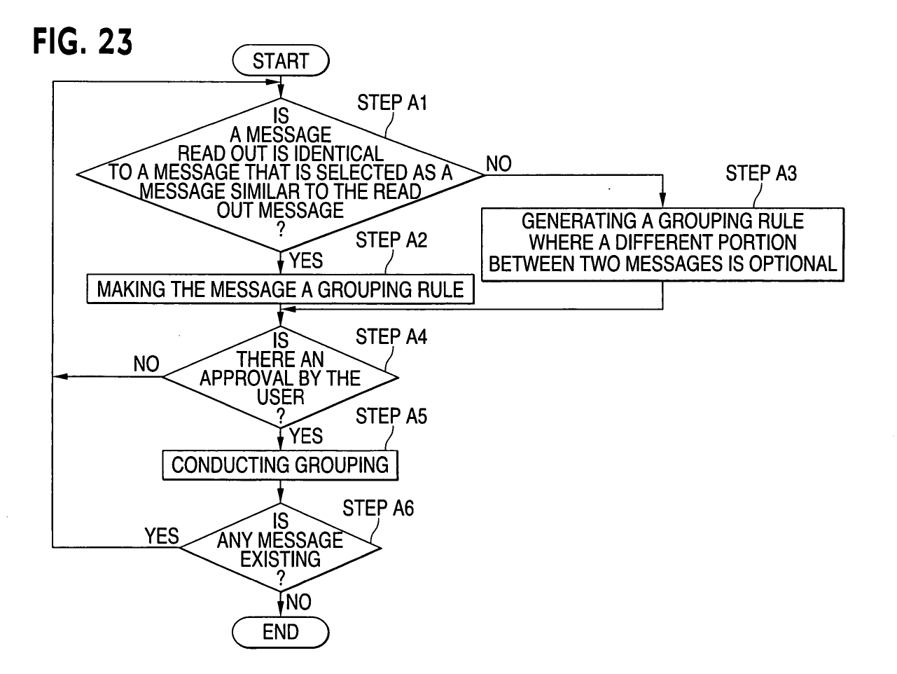

The server performs the grouping as follows as illustrated in FIG. 23. FIG. 23 is a flowchart for explaining the grouping of the first embodiment.

First, the server selects the message which is most similar to the message of the client 1. Here, the server selects the message of the client 5 as the message which is most similar to the message of client 1.

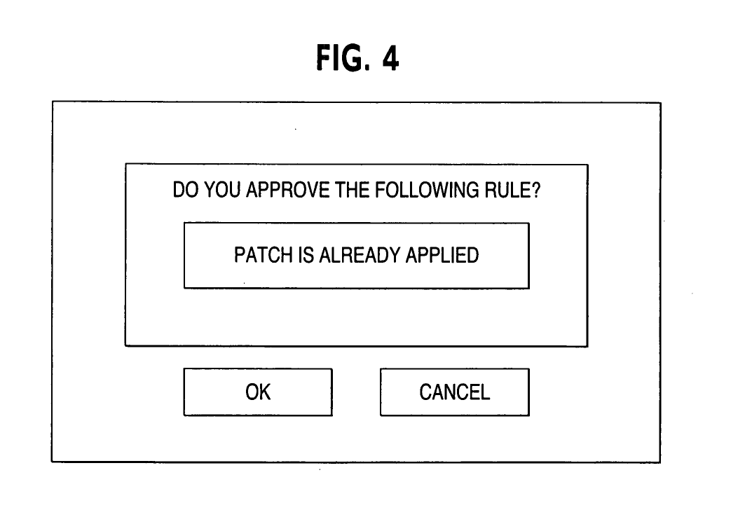

Since the message of the client 1 is totally identical to the message of the client 5 (step A1), the server generates the grouping rule “patch is already applied.” (step A2) and inquires to a user whether the user approves the generated grouping rule or not by presenting to the user the verification dialog as illustrated in FIG. 4.

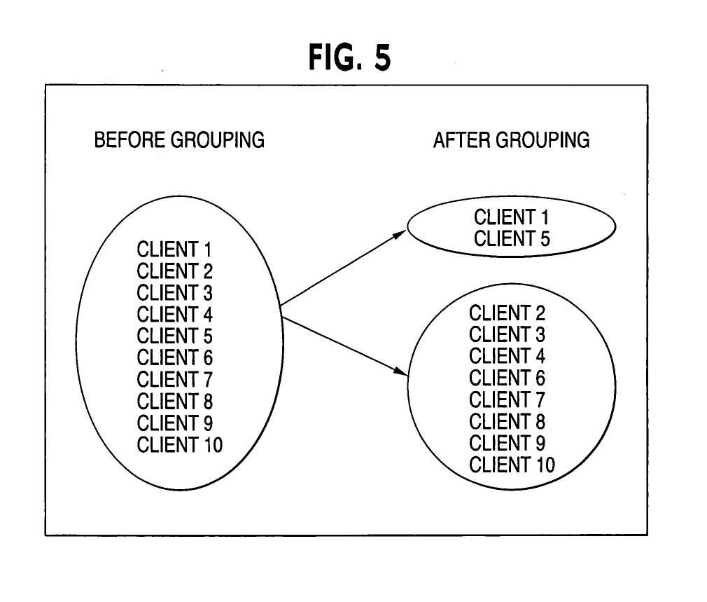

When user selects OK for the verification dialog of FIG. 4, the generated grouping rule is approved (step A4) and the grouping is conducted conforming to this approved grouping rule (step A5). Accordingly, as illustrated in FIG. 5, the messages of the client 1 and client 5 are grouped into a group.

Next, the server selects the message which is most similar to the message of the client 2. Here, the server selects the message of the client 6 (or client 8, 10) as the message which is most similar to the message of the client 2.

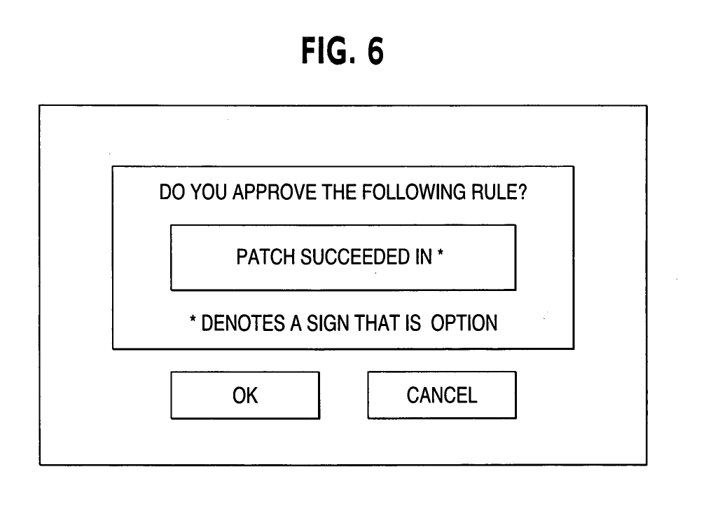

The server compares the message of the client 2 with the message of the client 6 (or client 8, 10) and generates the grouping rule “patch succeeded in *.” (step A1, step A3). Thereafter, the server enquires to a user whether the user approves the generated grouping rule or not by presenting to the user the verification dialog as illustrated in FIG. 6.

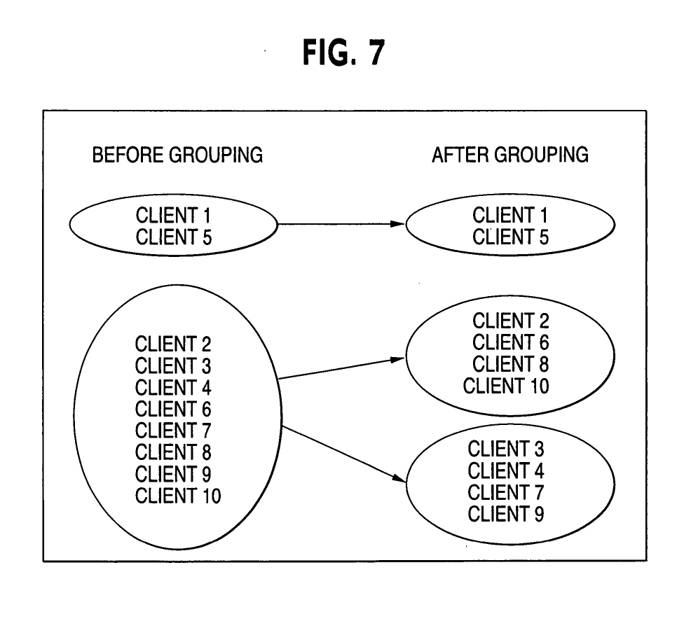

When the user selects OK for the verification dialog of FIG. 6, the grouping rule is approved (step A4) and the grouping is conducted conforming to this approved grouping rule (step A5). Accordingly, as illustrated in FIG. 7, the messages of the clients 2, 6, 8, and 10 are grouped into a group.

Next, the server selects the message that is most similar to the message of the client 3. Here, the server selects the message of the client 9 as the message which is most similar to the message of the client 3.

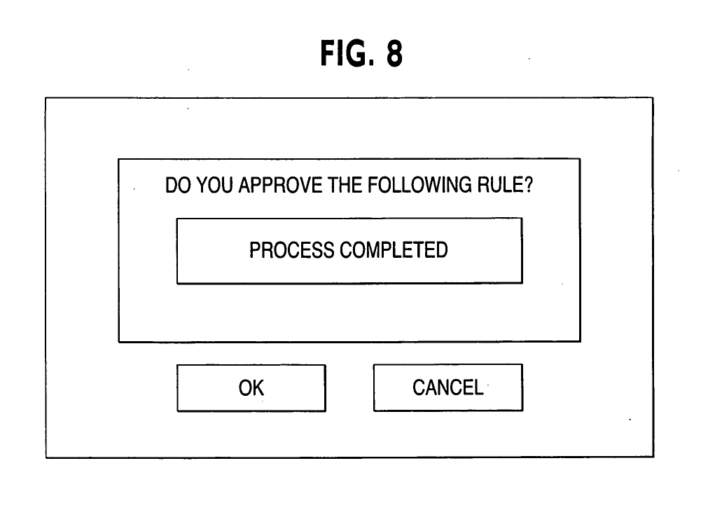

Since the message of the client 3 is totally identical to the message of the client 9 (step A1), the server generates (step A2) the grouping rule “Process Completed.” and inquires to a user whether the user approves this generated grouping rule or not by presenting the verification dialog as illustrated in FIG. 8.

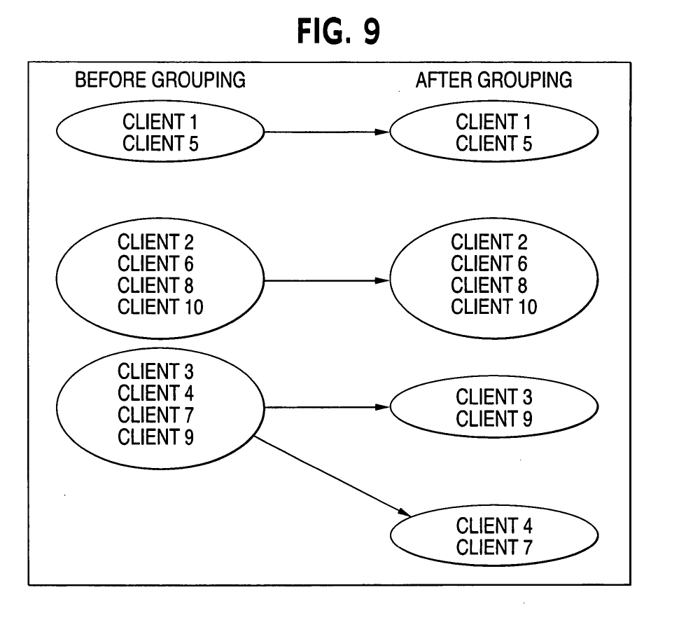

When the user selects OK for the verification dialog of FIG. 8, the generated grouping rule is approved (step A4) and the grouping is conducted (step A5) conforming to the approved grouping rule. Accordingly, the messages of the client 3 and client 9 are grouped into a group as illustrated in FIG. 9.

Next, the server selects the message which is most similar to the message of the client 4. Here, the server selects the message of the client 7 as the message which is most similar to the message of the client 4.

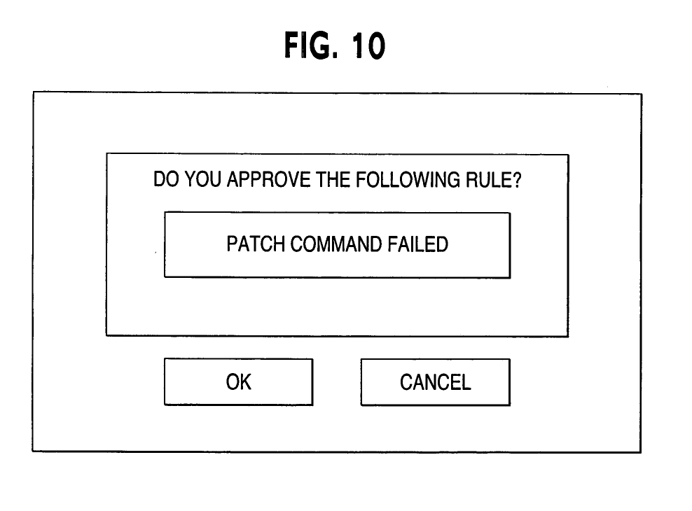

Since the message of the client 4 is quite identical to the message of the client 7 (step A1), the server generates a groping rule. “patch command failed.” (step A2) and enquires to a user whether the user approves the generated grouping rule or not by presenting the verification dialog as illustrated in FIG. 10.

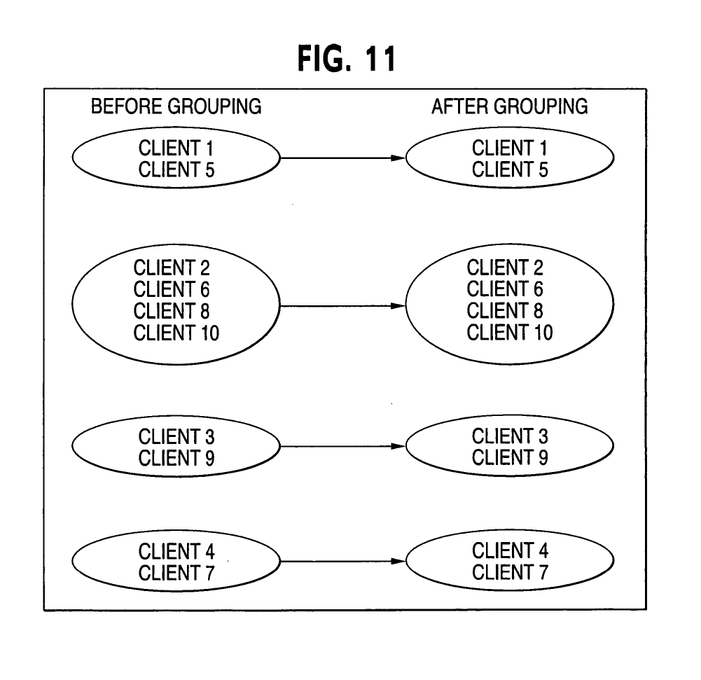

When the user selects OK for the verification dialog of FIG. 10, the generated grouping rule is approved (step A4) and the grouping is conducted conforming to the approved grouping rule (step A5). Accordingly, the messages of the clients 4 and 7 are grouped into a group as illustrated in FIG. 11.

The server completes the grouping because the messages which are not yet groups do not exist (step A6).

According to the first embodiment, the server is capable of grouping the exactly identical messages into the same groups.

Moreover, according to the first embodiment, when the inherent portions of client such as the computer name and IP address are included in the message, the server presents the grouping rule indicating only difference in the inherent portions to a user to inquire to a user whether the user accepts the grouping rule or not.

The server conducts the grouping conforming to the rule when the grouping rule presented is accepted by the user and moreover sequentially groups the messages which are not yet grouped with the similar grouping method conforming to such grouping rule.

Therefore, according to the first embodiment, the server is capable of grouping the messages which are different only in the inherent portions of the client such as the computer name and IP address into the same group.

### Second Embodiment

The messages transmitted to the server from each client are designated as follows.
Client 1: patch is already applied.
Client 2: patch succeeded in computer 2.
Client 3: Process Completed.
Client 4: invalid parameter.
Client 5: patch is already applied.
Client 6: patch succeeded in computer 5.
Client 7: file access error occurred.
Client 8: patch succeeded in computer 8.
Client 9: Process Completed.
Client 10: patch succeeded in computer 10.

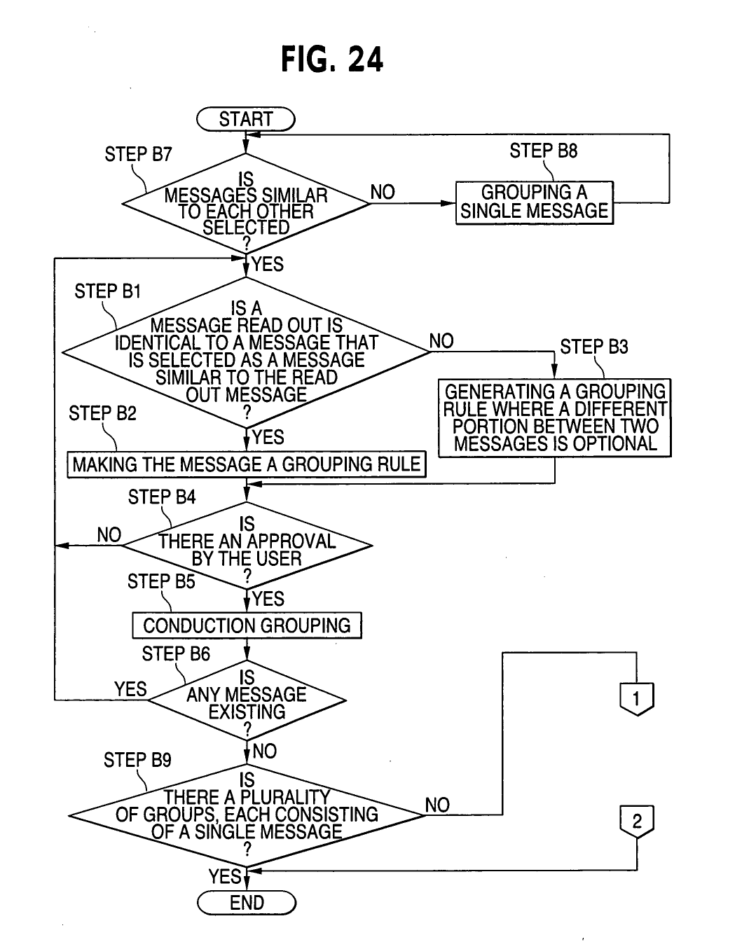

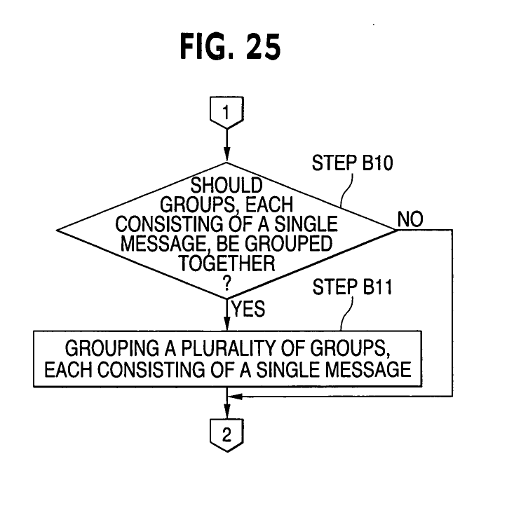

The server conducts the grouping as explained below as illustrated in FIG. 24 and FIG. 25. FIG. 24 is the flowchart (No. 1) for explaining the grouping of the second embodiment. FIG. 25 is the flowchart (No. 2) for explaining the grouping of the second embodiment.

First, the server selects the message which is most similar to the message of the client 1 (step B7). Here, the server selects the message of the client 5 as the message which is most similar to the message of the client 1.

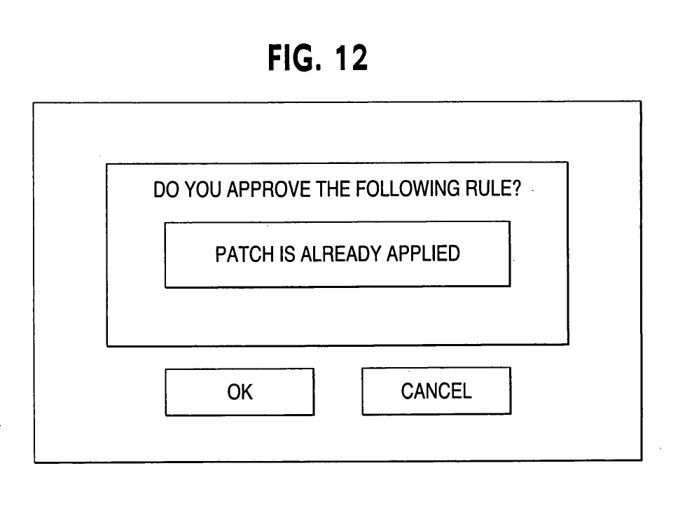

Since the message of the client 1 is totally identical to the message of the client 5 (step B1), the server generates the grouping rule “patch is already applied.” (step B2) and inquires to a user whether the user approves the generated grouping rule or not by presenting the verification dialog as illustrated in FIG. 12.

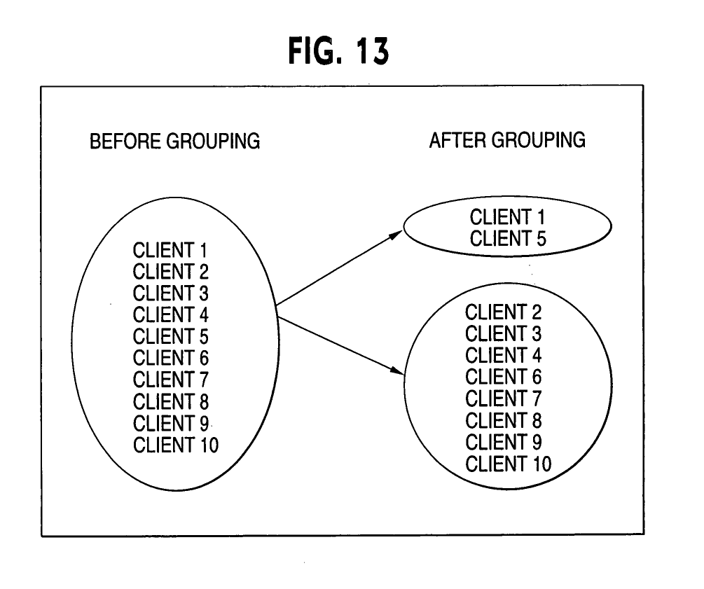

When the user selects OK for the verification dialog of FIG. 12, the generated grouping rule is approved (ste B4) and the grouping is conducted conforming to the approved grouping rule (step B5). Accordingly, the messages of the clients 1 and 5 are grouped into a group as illustrated in FIG. 13.

Next, the server selects the message which is most similar to the message of the client 2 (step B7) Here, the server selects the message of the client 6 (or client 8, 10) as the message which is most similar to the message of the client 2.

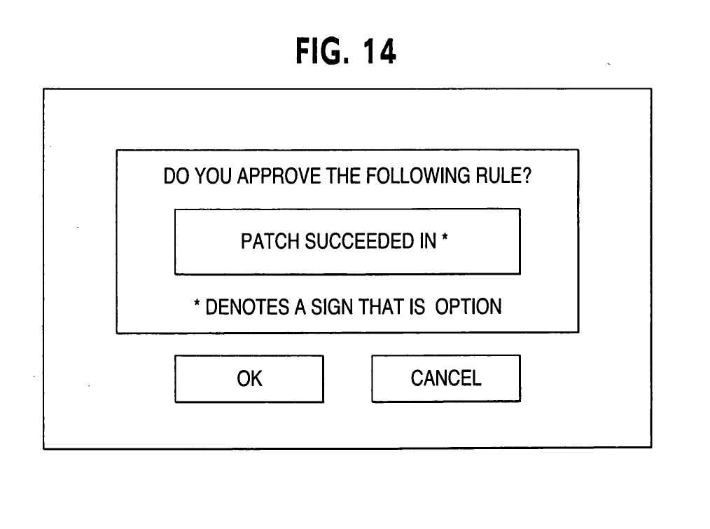

The server compares the message of the client 2 with the message of the client 6 (or client 8, 10) and generates the grouping rule “patch succeeded in *.” (step B3) to inquire to a user whether the user approves the generated grouping rule or not by presenting the verification dialog as illustrated in FIG. 14.

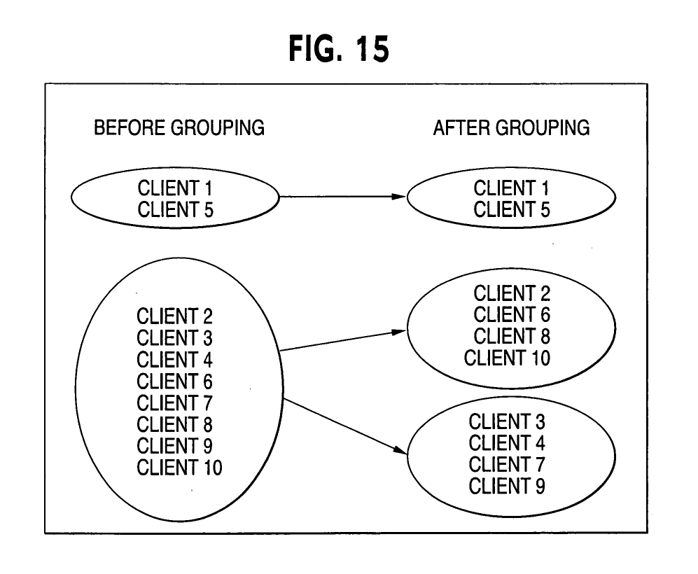

When the user selects OK for the verification dialog of FIG. 14, the generated grouping rule is approved (step B4) and the grouping is conducted conforming to the approved grouping rule (step B5). Accordingly, the messages of the clients 2, 6, 8, and 10 are grouped into a group as illustrated in FIG. 15.

Next, the server selects the message which is most similar to the message of the client 3 (step B7). Here, the server selects the message of the client 9 as the message which is most similar to the message of the client 3.

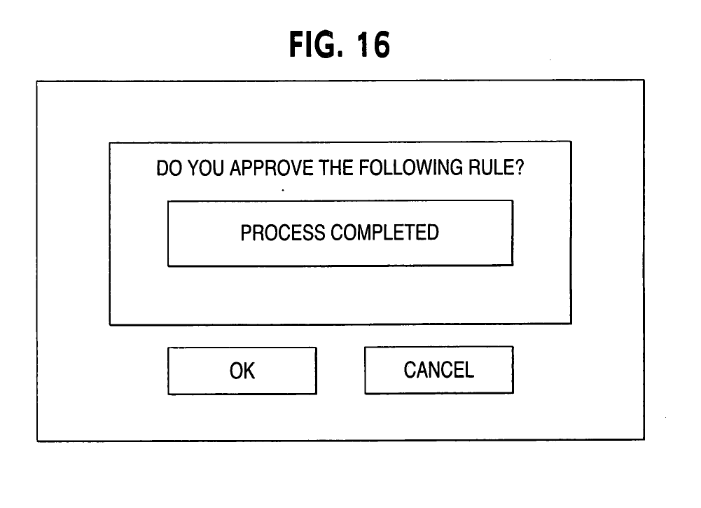

Since the message of the client 3 is totally identical to the message of the client 9 (step B1), the server generates the grouping rule “Process Completed.” (step B2) and inquires to a user whether the user approves the generated grouping rule or not by presenting the verification dialog as illustrated in FIG. 16.

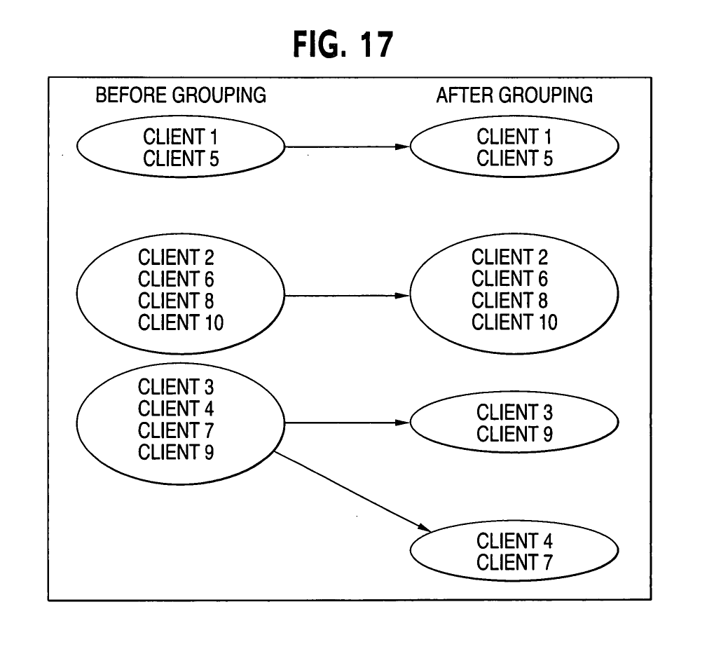

When the user selects OK for the verification dialog of FIG. 16, the generated grouping rule is approved (step B4) and the grouping is conducted conforming tot the approved grouping rule (step B5). Accordingly, the messages of the clients 3 and 9 are grouped into a group as illustrated in FIG. 17.

Next, the server selects the message which is most similar to the message of the client 4 (step B4). Here, the server is assumed that it cannot select the message which is most similar to the message of the client 4.

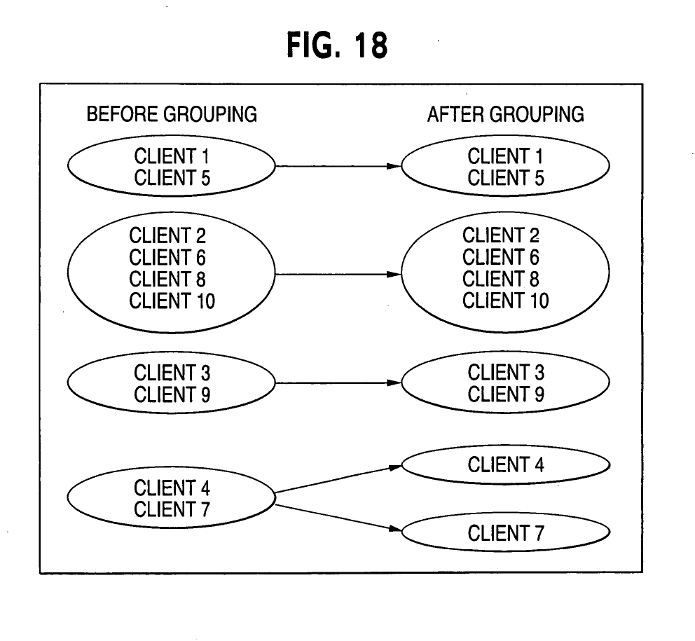

In this case, the server groups the messages of the client 4 into a group as illustrated in FIG. 18 (step B8).

Next, the server tries selection of the message which is most similar to the message of the client 7 (step B7) but it cannot select the message similar to that of the client 7 because only the message of the client 7 is not yet grouped.

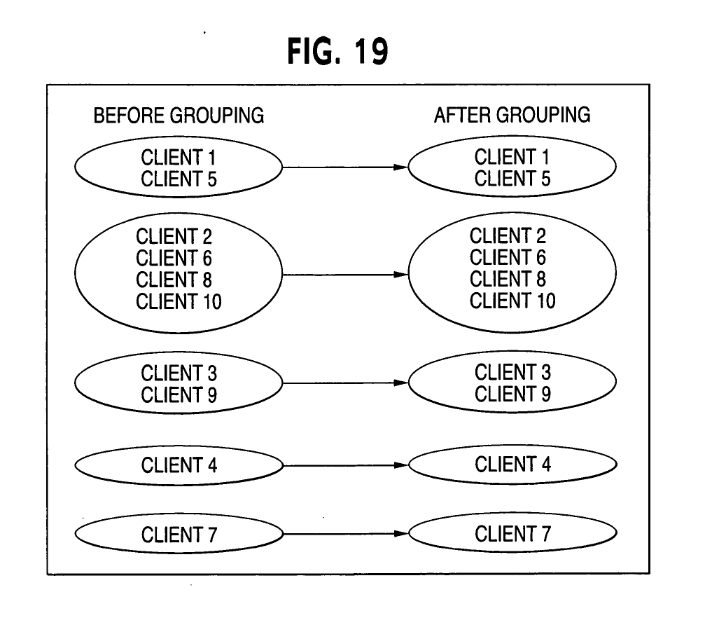

Therefore, the server groups only the message of the client 7 as a group (step B8) as illustrated in FIG. 19.

The server searches (step B9) whether a plurality of groups formed of only one message exist or not because the message which is not yet groups does not exist (step B6).

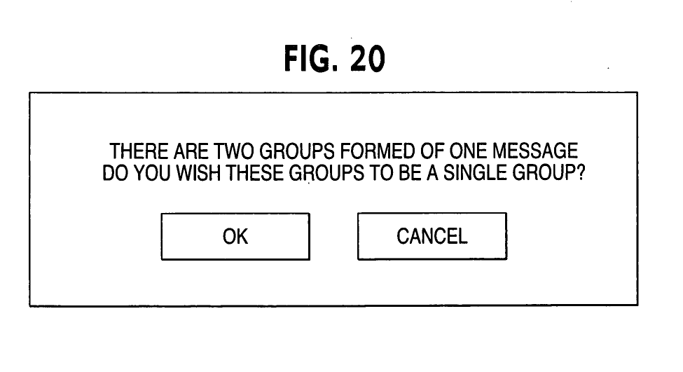

Since a plurality of groups formed of only one message exist, the server inquires to a user whether a plurality of groups should be grouped into a group having no similar message or not by presenting to the user the verification dialog as illustrated in FIG. 20 (step B10).

When the user select OK for the verification dialog of FIG. 20, the server groups the groups formed of only one message into a group having no similar message (step B11).

On the other hand, when the user selects cancellation of the verification dialog of FIG. 20, the server leaves the group formed of only one message as the group formed of only one message.

According to the second embodiment, when the message which is not similar to any message exists, it is possible that this message is grouped as the group formed of only one message and thereafter the group formed of only one message is grouped into a group.

(Effect of the Invention)

As explained above, according to the embodiments of the present invention, when the messages transmitted from the clients who have succeeded in installation of application and application of patch (hereinafter referred to as the “successful message”) are identical among the clients, these messages can be grouped into a group with single grouping process.

Moreover, according to the embodiments of the present invention, even when the successful messages include the inherent portions of the client such as computer name and IP address, the messages including such inherent portions can be grouped into a group with the single grouping process.

Therefore, according to the embodiments of the present invention, a user can easily discriminates within a short period of time that the processes such as installation and application in each client have been succeeded or not.

In addition, according to the embodiments of the present invention, even when the error messages transmitted from the clients have variable formats, the error messages having such variable formats can be grouped only with a plurality of times of the grouping process.

Moreover, according to the embodiments of the present invention, a user can easily verify messages because it is enough for the messages of each client to be verified as many times as the number of groups.

According to the embodiments of the present invention, a user is capable of conducting the grouping of messages in accordance with the grouping rule approved with the same user. Therefore, according to the embodiments of the present invention, a user can easily verify the messages within a short period of time because the user can conduct the grouping as the same user desires.

The grouping rule generating block 2 in the embodiments of the present invention compares two messages with each other as explained above and generates a rule for the desired different portion among these two messages. However, the grouping rule in the embodiments of the present invention is not limited only to this grouping rule.

Accordingly, the grouping rule generating block in the present invention is also capable of comparing, for example, n (n is an integer equal to 2 or larger) messages and thereby generating a rule only for the desired different portion among these n messages.

Therefore, according to the present invention, a degree of grouping of the messages can be adjusted.

Industrial Field of Utilization

The present invention can be used for the server to verify results of processes by the clients.

1. A client server system including a plurality of clients and a server, characterized in that
said clients transmit messages to said server, and
said server comprises a grouping rule generating block for generating a grouping rule on the basis of a result of comparison of messages from said clients and a grouping block for grouping messages from said clients on the basis of the grouping rule generated by said grouping rule generating block.

2. The client server system according to claim 1, characterized in that said grouping rule generating block of said sever selects two similar messages from the messages from said clients and generates a rule for different portions of these two messages and said grouping block of said server groups the messages different from said two messages to a group only at said desired portions on the basis of the grouping rule generated by said grouping rule generating block.

3. A grouping method in the client server system including a plurality of clients and a server, characterized in comprising
a step in which said clients transmit messages to said server,
a grouping rule generating step in which said server compares the messages from said clients with each other and generates a grouping rule on the basis of the result of comparison, and
a grouping step in which the server groups the messages from said clients go a group on the basis of said generated grouping rule.

4. The grouping method according to claim 3, characterized in that
similar two messages are selected from the messages from said clients and a rule for the desired different portions in these two messages is generated in said grouping rule generating step, and
said two different messages are grouped into a group only at said desired portion on the basis of said generated grouping rule in said grouping step.

5. A server characterized in comprising
a grouping rule generating block for comparing the messages with each other from a plurality of clients and generating a grouping rule on the basis of the result of comparison, and
a grouping block for grouping the messages from said clients on the basis of the grouping rule generated by said grouping rule generating block.

6. The server according to claim 5, characterized in that
said grouping rule generating block selects similar two messages from the messages from said clients and generates a rule for different portions in these two messages, and
said grouping block groups the messages different from said two messages only at said desired portions on the basis of the grouping rule generated by said grouping rule generating block.

7. A grouping method characterized in controlling the server to execute,
a grouping rule generating step for comparing the messages from clients and generating a grouping rule on the basis of the result of comparison, and
a grouping step for grouping messages from said clients on the basis of said generated grouping rule.

8. The grouping method according to claim 7, characterized in that
similar two messages are selected from the messages from said clients and a rule is generated for the desired different portions of these two messages in said grouping rule generating step, and
the messages different from said two messages are grouped into a group only at said desired portions on the basis of said generated grouping rule in said grouping step.

9. A grouping program characterized in controlling the server to execute
a grouping rule generating step for comparing with each other the messages from clients and generating a grouping rule on the basis of result of comparison, and
a grouping step for grouping the messages from said clients on the basis of said generated grouping rule.

10. The grouping program according to claim 9, characterized in that
similar two messages are selected from the messages from said clients and a rule for different portions of these two messages is generated in said grouping rule generating step, and
the messages different from said two messages only at said desired portions are grouped into a group on the basis of said generated grouping rule in said grouping step.

11. A computer-readable storage medium storing the grouping program of claim 9.

12. A client characterized in transmitting said messages to a server comprising a grouping rule generating block for comparing with each other the messages from clients and generating a grouping rule on the basis of the result of comparison and a grouping block for grouping the messages from said clients on the basis of the grouping rule generated by said grouping rule generating block.

13. The client according to claim 12, characterized in that
said grouping rule generating block of said server selects similar two messages from the messages from said clients and generates a rule for desired different portions of these two messages, and
said grouping block of said server groups the messages different from said two messages into a group only at said desired portion on the basis of the grouping rule generated by said grouping rule generating block.
